(19) United States
(12) Patent Application Publication
(10) Pub. No.: US 2012/0286647 A1
(43) Pub. Date: Nov. 15, 2012

(54) Phosphor converted LED

(75) Inventors: Peter Josef Schmidt, Aachen (DE); Hans-Helmut Bechtel, Roetgen (DE)

(73) Assignee: KONINKLIJKE PHILIPS ELECTRONICS N.V., EINDHOVEN (NL)

(21) Appl. No.: 13/522,723

(22) PCT Filed: Jan. 27, 2011
(86) PCT No.: PCT/IB2011/050362

§ 371 Date: Jul. 18, 2012

(30) Foreign Application Priority Data
Feb. 3, 2010 (EP) 10152489.0

(51) Int. Cl. H01J 1/63

(52) U.S. Cl. 313/503

(57) ABSTRACT

The invention is directed to a light emitting comprising a blue emitting LED, a first phosphor layer exited at the emitting wavelength of the LED, which phosphor has an emission wavelength within a range of between 500 nm and 560 nm, and a second phosphor layer having a color point u′ in the range between 0.24 and 0.35 and a peak emission of the phosphor layer of λp>600 nm of the emission spectra, especially a pcLED comprising a combination of a green emitting luminescent ceramic material and a second phosphor material having a broad emission spectra. The second phosphor material can comprise a compound of the general formula M_{1-x-y-z}Si_{1+z}Al_{1-z}N_{3-z}O_{z}:Eu²⁺ₓCe²⁺_{y}, whereby M is selected from the group consisting of Ca, Sr or mixtures thereof and 0.0001≦x≦0.005; 0.001≦y≦0.05 and 0≦z≦0.25.

### FIELD OF THE INVENTION

The present invention is directed to novel light emitting device comprising a stack of luminescent layers, especially a pcLED comprising a combination of a green emitting luminescent ceramic material and an orange emitting luminescent layer.

### BACKGROUND OF THE INVENTION

Phosphors comprising silicates, phosphates (for example, apatite) and aluminates as host materials, with transition metals or rare earth metals added as activating materials to the host materials, are widely known. As blue LEDs, in particular, have become practical in recent years, the development of white light sources utilizing such blue LEDs in combination with such phosphor materials is being energetically pursued.

Today's warm white phosphor converted LEDs (pcLEDs) are produced e.g. by combining a YAG phosphor with a red phosphor powder layer. Variations in phosphor layer thickness currently lead to variation of the white LED color point away from the Planckian locus, which in general is an aim. An advantage of layered phosphor combinations compared to a powder mixture of two phosphor layers is a reduced interaction of the phosphors, i.e. absorption of emitted light of the green phosphor by the red emitting phosphor. Due to variations in the red phosphor layer thickness the resulting change of color moves away from the Planckian locus and the resulting emission color is no longer white.

Different color emitting luminescent materials have been in the focus of interest and several materials have been proposed, e.g. in the Journal of Materials Science, 2009, V 44, p 4763-4775.

However, there is still the continuing need for warm white phosphor converted LEDs having a optimized luminous efficiency and color rendering which are usable within a wide range of applications.

### SUMMARY OF THE INVENTION

It is an object of the present invention to provide a warm white pcLED with optimized luminous efficiency and color rendering.

This object is solved by a light emitting device according to claim 1 of the present invention. Accordingly, a light emitting device is provided, comprising a blue emitting LED, a first phosphor layer exited at the emitting wavelength of the LED, which ceramic phosphor has an emission wavelength within a range of between 500 nm and 560 nm, and a second phosphor layer having a color point u′ in the range between 0.24 and 0.35 and a peak emission of the phosphor layer of λp>600 nm.

It should be understood that u′ is defined by the definitions of the uniform color space CIE 1976. According to CIE 1976 and CIE Standard S 014-5/E:2009 u′ is defined as:

$${u}^{′} = \frac{4 x}{- 2 x + 12 y + 3}$$

In an embodiment according to the invention the phosphor having a color point u′ in the range between 0.24 and 0.35 and a peak emission of the phosphor layer of λp >600 nm comprises a material according to the general formula

M_{1-x-y-z}Si_{1+z}Al_{1-z}N_{3-z}O_{z}:Eu²⁺ₓCe²⁺_{y}, whereby

M is selected from the group consisting of Ca, Sr or mixtures thereof; and whereby

0.0001≦x≦0.005; 0.001≦y≦0.05 and 0≦z≦0.25.

It should be noted that by the term “M_{1-x-y-z}Si_{1+z}Al_{1-z}N_{3-z}O_{z}:EU²⁺ₓCe²⁺_{y}” especially and/or additionally any material is meant and/or included, which has essentially this composition.

The term “essentially” means especially that ≧95%, preferably ≧97% and most preferred ≧99% wt-%.

Such a material has shown for a wide range of applications within the present invention to have at least one of the following advantages:

Using the material as luminescent layer, LEDs may be built which show improved lighting features, especially color rendering in warm white phosphor converted LEDs.

The material has been found to have a broad band emission and an appropriate red emission especially suited for white pcLEDs.

The material has been found to be capable to compensate color variations caused by varying layer thickness of red phosphor layers in pcLEDs.

According to a preferred embodiment of the present invention, x is ≧0.0001 and ≦0.005, preferably ≧0.0002 and ≦0.0005. This has been found to be advantageous for many applications, since when x is too high, the color point of the material is not in the range to compensate the color variations caused by the varying thickness red phosphor layers in pcLEDs. If x is too low, the color rendering properties deteriorate.

According to a preferred embodiment of the present invention, the luminescent material is a ceramic body. The term “ceramic” in the sense of the present invention means and/or includes especially a crystalline or polycrystalline compact material or composite material with a controlled amount of pores or which is pore free.

According to a preferred embodiment of the present invention, y is ≧0.001 and ≦0.04, preferably ≧0.002 and ≦0.005, and more preferred ≧0.02 and ≦0.03. In the material as defined above Ce is deemed to act as a second emitting material. Ce doping makes the material emitting in a green to orange color range, while Eu doping makes the material emitting in a deep red color range. Surprisingly, doping of the material with both rare-earth elements makes the material emitting in the inventive way.

According to a preferred embodiment of the present invention, z is ≧0.05 and ≦0.25, preferably ≧0.1 and ≦0.15. In general, the oxygen content in the material is deemed to be a result of impurities of the basic material. However, if the contend of oxygen in the material is too high, the red component of the emission will be too low. This makes the material emitting in a yellow range, rather than emitting in the intended color range.

According to a preferred embodiment, the content of Ca in M is ≧80% (mol/mol), more preferred ≧90%.

According to another preferred embodiment, the content of Sr in M is ≧80% (mol/mol), more preferred ≧90%.

The material has a color point u′ in a CIE chromaticity diagram in the range of between 0.24 and 0.35.This has been found to be advantageous for many applications, since this color point is appropriate to compensate color variations of red phosphor layers in pcLEDs.

The peak emission of the second phosphor layer λp is >600 nm, preferably λp is >610 nm. This has been found to be advantageous for many applications, since it enables an adequate color rendering CRI>75.

According to an embodiment of the invention, the blue emitting LED may have a peak emission wavelength within the range of between 400 nm and 480 nm. This has been found to be advantageous for many applications, since such an emission wavelength excites the ceramic green emitting phosphors as well as the phosphor layer having a color point u′ in the range between 0.24 and 0.35 and a peak emission of the phosphor layer of λp>600 nm in a way, that an optimized luminous efficiency and color rendering can be achieved.

According to an embodiment of the invention, the first phosphor layer is a sintered polycrystalline ceramic body. The ceramic body may have a layer thickness within the range of between 80 μm and 300 μm. In a preferred embodiment, the first phosphor layer is a ceramic body, like e.g. a Lumiramic™

In a further embodiment according to the invention, the phosphor layer having a color point u′ in the range between 0.24 and 0.35 and a peak emission of the phosphor layer of λp>600 nm is a mixture of different phosphor materials, which mixture leads to a phosphor layer having the mentioned properties with respect to the color point and the peak emission wavelength of the emission spectra. In an embodiment, the mixture comprises a first luminescent material of the general formula Lu₃Al₅O₁₂:Ce or SrSi₂O₂N₂:Eu and a second luminescent material which may be a conventional red phosphor material, like e.g. CaAlSi(N,O)₃:Eu, CaSiN₂:Eu, CaSi₅N₈:Eu, or Sr₂SiN₂:Eu.

The present invention furthermore relates to a light emitting material, especially a LED, comprising at least one material as described above.

A light emitting device according to the present invention may be of use in a broad variety of systems and/or applications, amongst them one or more of the following:

office lighting systems

household application systems

shop lighting systems,

home lighting systems,

accent lighting systems,

spot lighting systems,

theater lighting systems,

fiber-optics application systems,

projection systems,

self-lit display systems,

pixelated display systems,

segmented display systems,

warning sign systems,

medical lighting application systems,

indicator sign systems, and

decorative lighting systems

portable systems

automotive applications

green house lighting systems

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

### BRIEF DESCRIPTION OF THE DRAWINGS

Additional details, features, characteristics and advantages of the object of the invention are disclosed in the subclaims, the figures and the following description of the respective figures and examples, which—in an exemplary fashion—show several embodiments and examples of materials according to the invention.

FIG. 1 shows CIE 1976 color coordinates of an of a state of the art pcLED comprising a red phosphor and a pcLED comprising a luminescent material according to an embodiment of the invention; and

FIG. 2 shows CIE 1976 color coordinates with color points for a blue LED, a green luminescent ceramic (Lumiramic™) and an orange luminescent material according to an embodiment of the invention; and

FIG. 3 shows a comparison of an emission spectrum of a luminescent material according to an embodiment of the invention and of a red phosphor according to the state of the art.

FIG. 4 shows the emission spectra of another embodiment according to the invention.

### DETAILED DESCRIPTION OF THE EMBODIMENTS

The invention will be further understood by the figures and the following description.

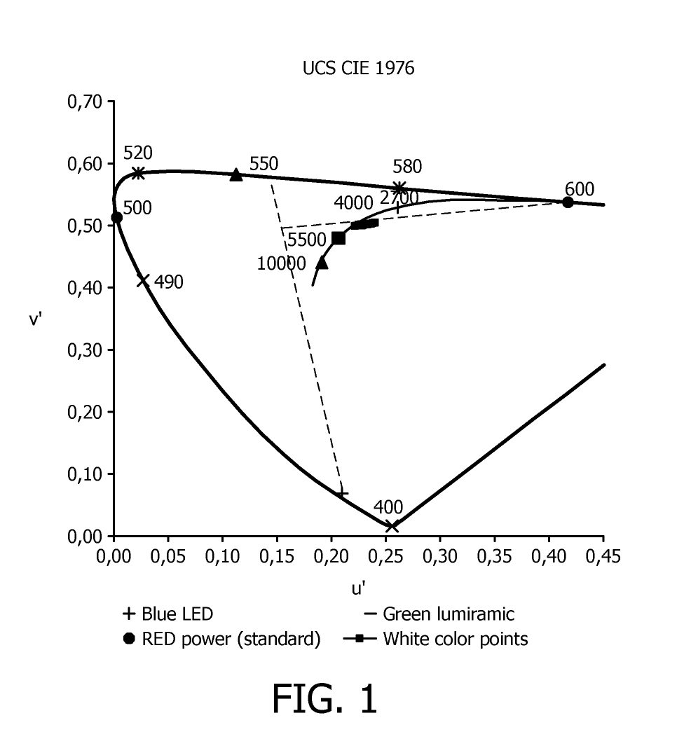

FIG. 1 shows CIE 1976 color coordinates of a state of the art pcLED comprising a red phosphor and a pcLED comprising a luminescent material according to an embodiment of the invention having the generic formula CaSiAlN_{3-z}O_{z}:Eu² ₓCe²⁺_{y}, whereby x is 0.004, y is 0.01 and z is 0.06. FIG. 1 represents the variation of the color points of a state of the art combination of a lumiramic with a red phosphor at increasing thickness of the red phosphor layer (thickness increasing from left to right). As it can be seen the color point strongly depends on the layer thickness of the red phosphor layer. On the other hand, the color point of the luminescent material according to the invention is varying almost only along the Planckian with varying thickness of the red/orange phosphor layer. This is due to the broad band emission of the inventive luminescent material, which enables good color rendering CRI>75 for white LEDs.

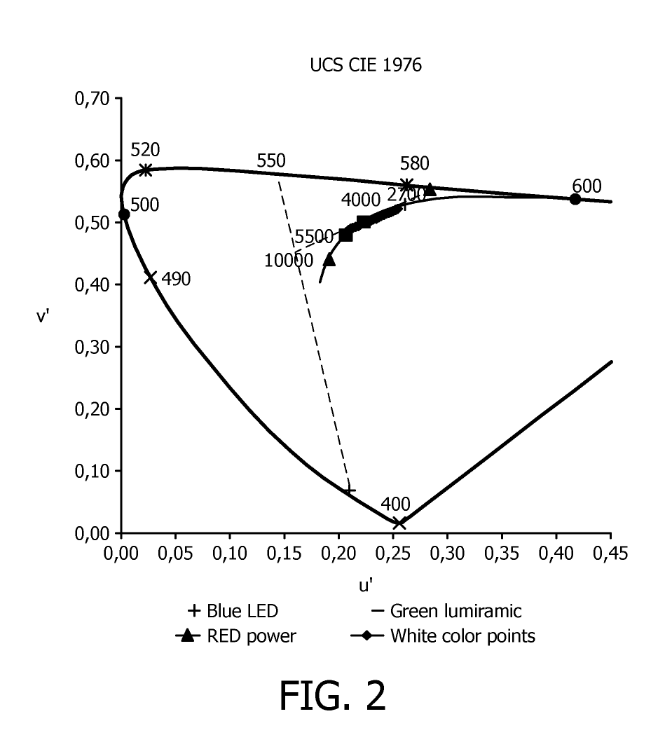

FIG. 2 shows CIE 1976 color coordinates with color points for a blue LED, a green luminescent ceramic (Lumiramic™) and an orange luminescent material according to an embodiment of the invention. In order to realize a red and green phosphor combination with superior layer thickness tolerance for viable production of with LEDs and maintaining good color rendering a luminescent material (orange phosphor) according to the invention is selected and combined in a pcLED-device with an green luminescent ceramic (Lumiramic™). As shown in FIG. 2, the white color points vary along the Planckian with varying thickness of the red/orange phosphor layer. The use of a luminescent material according to the invention therefore makes the production of white pcLEDs on basis of a blue emitting LED much more reliable since the effect of the phosphor layer thickness on the color point is significantly reduced.

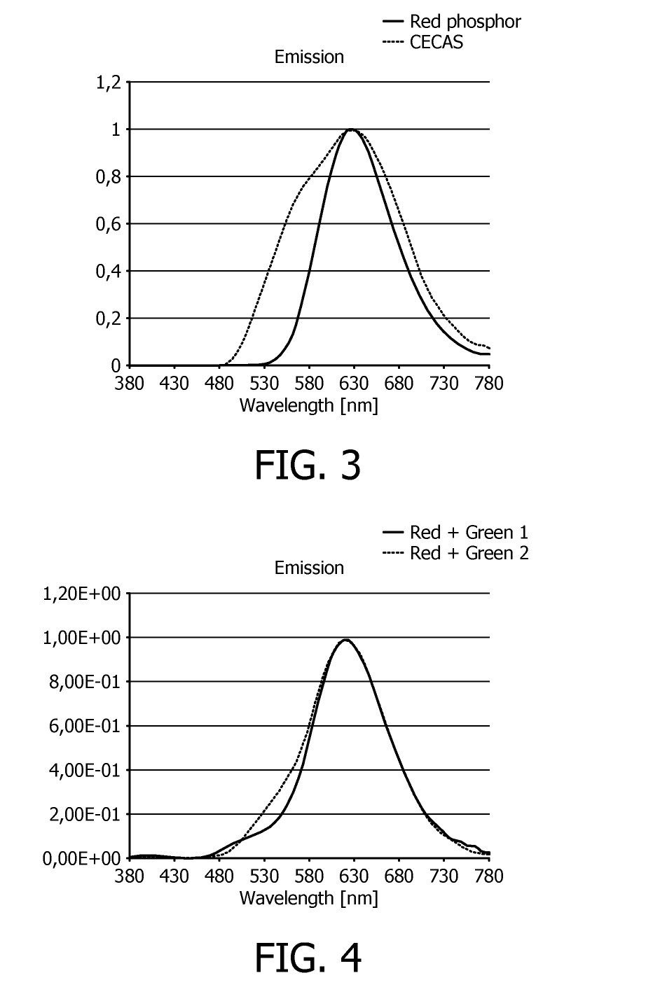

FIG. 3 shows an emission spectrum of a luminescent material (CECAS) according to the generic formula CaSiAlN_{3-z}O_{z}:Eu²⁺ₓCe²⁺_{y}, whereby x is 0.004,y is 0.01 and z is 0.06 for 450 nm excitation with an emission maximum at about 625 nm and an FWHM (full width half maximum) of more than 120 nm. Such a broad emission enables to compensate layer thickness variation of the phosphor layer over a wide range. In comparison the emission spectra of a conventional red phosphor is shown.

FIG. 4 shows the emission spectra of another embodiment according to the invention. Here, two different green phosphors are mixed with a conventional red phosphor to achieve the desired color point. The first green phosphor is a luminescent material according to the general formula Lu₃Al₅O₁₂:Ce, while the second green phosphor is a luminescent material according to the general formula SrSi₂O₂N₂:Eu. The green phosphors are mixed as powders, individually, with a red phosphor powder in a ratio of 1:2 by weight. 16.2% vol.-% of the mixed phosphor powders were added to a silicone. The spectra were measured using a layer with a thickness of the silicon—phosphor-mixture of about 25 μm. As one can see in the spectra, the resulting phosphor mixtures have a λp>600 nm.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. The invention's scope is defined in the following claims and the equivalents thereto. Furthermore, reference signs used in the description and claims do not limit the scope of the invention as claimed.

1. A light emitting device, comprising a blue emitting LED, a first phosphor layer excited at the emitting wavelength of the LED, which phosphor has an emission wavelength within a range of between 500 nm and 560 nm, and a second phosphor layer having a color point u′ in the range between 0.24 and 0.35 and a peak emission of the phosphor layer of λp>600 nm of the emission spectra.

2. The light emitting device of claim 1 with at least one phosphor layer being a ceramic body having a thickness D wherein D>80 μm and <300 μm.

3. The light emitting device of claim 1, wherein the second phosphor layer comprises a material according to the general formula M_{1-x-y-z}Si_{1+z}Al_{1-z}N_{3-z}O_{z}:Eu²⁺ₓCe²⁺_{y}, wherein M is selected from the group consisting of Ca, Sr or mixtures thereof; and wherein 0.0001≦x≦0.005; 0.001≦y≦0.05 and 0≦z≦0.25.

4. The light emitting device of claim 3, wherein x is ≧0.0001 and ≦0.005.

5. The light emitting device of claim 3, wherein y is ≧0.005 and ≦0.04.

6. The light emitting device of claim 3, wherein z is ≧0.05 and ≦0.25.

7. The light emitting device of claim 3, wherein the content of Ca in M is ≧80% (mol/mol).

8. The light emitting device of claim 3, whereby the content of Sr in M is ≧80% (mol/mol).

9. The light emitting device according claim 1 or 8, whereby the phosphor layer comprises at least two luminescent materials, wherein the first luminescent material is a red emitting material and the second luminescent material is a green/yellow emitting material.

10. The light emitting device according claim 1 or 9, wherein the blue emitting LED has a peak emission wavelength within the range of between 400 nm and 480 nm.

11. A system comprising a light emitting device according to any of claim 1, the system being used in one or more of the following applications:
office lighting systems
household application systems
shop lighting systems,
home lighting systems,
accent lighting systems,
spot lighting systems,
theater lighting systems,
fiber-optics application systems,
projection systems,
self-lit display systems,
pixelated display systems,
segmented display systems,
warning sign systems,
medical lighting application systems,
indicator sign systems, and
decorative lighting systems
portable systems
automotive applications
green house lighting systems
